(19) United States
(12) Patent Application Publication
(10) Pub. No.: US 2019/0177635 A1
(43) Pub. Date: Jun. 13, 2019

(54) COATING AGENT FOR SCREWS

(71) Applicant: SFS intec Holding AG, Heerbrugg (CH)

(72) Inventors: Markus Andersag, Lustenau (AT); Oliver Schuler, Sulzberg (AT)

(73) Assignee: SFS intec Holding AG, Heerbrugg (CH)

(21) Appl. No.: 16/213,285

(22) Filed: Dec. 7, 2018

(30) Foreign Application Priority Data
Dec. 11, 2017 (EP) 17206346.3

(51) Int. Cl. C10M 111/04; C10M 107/04; C10M 107/38; C10M 107/24; C10M 101/02; C10M 105/38; F16B 33/06

(52) U.S. Cl. CPC C10M 111/04; C10M 107/04; C10M 107/38; C10M 107/24; C10M 101/025; C10M 105/38; C10N 2250/121; C10M 2205/0225; C10M 2213/023; C10M 2209/043; C10M 2205/163; C10M 2205/183; F16B 33/06

(57) ABSTRACT

A coating agent for fasteners, in particular drilling screws and thread-forming screws, serves to improve the handling safety and reliability. For this purpose, the agent includes at least two different solid lubricants, with the first solid lubricant being a plastic or a wax and the second solid lubricant being at least one further plastic. These solid lubricants are preferably present in a solution, for example in a water-based, alcohol-based, or another, in particular organic solvent-based solution. The solid lubricants are preferably present as a micro-granulate, which achieves a better distribution in the coating and therefore a better availability of the solid lubricants in the case of use. A method for coating such fasteners with such a coating agent is also the subject-matter of the present invention.

### INCORPORATION BY REFERENCE

The following documents are incorporated herein by reference as if fully set forth: European Patent Application No. 17206346.3, filed Dec. 11, 2017.

### FIELD OF THE INVENTION

The present invention relates to a coating agent for screws, in particular self-drilling, thread-forming or thread-cutting screws, which can significantly facilitate the screwing process.

### BACKGROUND

Improvements are always sought in connection technology which relate to handling, economic efficiency and safety. Especially in metal construction, it is frequently important for assembly in the construction industry to connect a multiplicity of elements to one another rapidly and reliably. An essential outlay conventionally lies in the pre-drilling of construction components which are to be connected together. The latter have to be temporarily fixed, drilled, the drill hole cleared and a connector or fastener introduced and fixed.

In this regard, self-drilling screws with their own drill head are advantageous, because they greatly simplify this multi-stage process. A fundamental problem, however, consists in the fact that this drill head can be used only once, but nonetheless has to be designed correspondingly especially when used in metal components. This significantly increases production costs for such a fastener. The thread of a self-drilling screw must also be designed to form a counter-thread in the surrounding material directly following the drilling process, which provides for high pull-out forces of the fastener used. In the case of a simple drill, milling tool, or another cutting tool, the application can be optimized by a high-quality material selection and a costly surface treatment (aluminum nitride, Cr—Al nitrides, carbides, diamond-like-carbon DLC). In the case of a drilling screw or thread-forming screw, these means are ruled out on cost grounds.

Especially in the case of self-drilling screws, a huge thermal load on all the components arises due to the drilling process. The latter arises on the one hand due to the friction of the drilling screw in the drill hole—which primarily relates to drill cutting. Its tool life diminishes drastically when the material is so hot that a plastic deformation of the drill head occurs. A screw usually fails at this point, because for example the screw breaks off or the drill cutting loses its integrity.

A further source of thermal energy is the deformation energy introduced into the drilled component, when the drill cutting forms the chip. A large part of this energy remains in the chip, for which reason it is important to enable a continuous and unhindered chip removal.

The heat transport processes for the aforementioned application are highly complex, highly dependent on geometry and material and cannot therefore be described as a single linear process.

### PRIOR ART

It is known in the prior art that drilling screws and thread-forming screws can be coated and methods and coating agents have also repeatedly been suggested in order to achieve the intended application described above. Sometimes mention is made here of slip agents, because the input of thermal energy into the material is reduced by the reduced friction. Dry slip films can be obtained, whereby a coating agent is deposited on the untreated fastener by a dipping method, a spray method or a centrifuge method and is then for example dried or UV-cured and thus fixed on the surface until use. The coats can be suitably hard, waxy, brittle or elastic.

For example, it is known, for use on screws, to make use of a suspension of micro-dispersed solid lubricants in an aqueous solution, which after drying at room temperature help to reduce the coefficient of friction in subsequent use. They include for example the products DF 911 and DF 921 of the company microGLEIT.

As additives for paints, plasters or for coating clothing, micro-encapsulated PCM (phase-change-materials) are known, which are capable of reversibly storing latent heat and releasing it again. These additives are present as solutions (salt hydrates, not considered here) or micro-encapsulated. The latter are used as heat buffers.

Furthermore, document EP 2 000 680 describes a coating agent for a thread-forming screw with a mixture comprising calcium montanate and a montanic acid in a thermoplastic resin emulsion.

WO 2016/023855 describes a drilling screw made of austentitic or stainless steel with a galvanically applied hard coating, onto which a coating comprising a lubricating or heat-dissipating material is in turn deposited.

Tests have shown that the commercially available agents and methods or those known from the prior art do increase the drilling or thread-forming performance, but the demands on present-day assembly work cannot be met.

### SUMMARY

The object of the invention, therefore, is in providing a coating agent which permits a greatly improved drilling performance, reduced forming moments and improved handling of such generic screws.

This is achieved by a coating having at least two different solid lubricants, the first solid lubricant is a plastic or a wax and the second solid lubricant is at least one further plastic.

### DETAILED DESCRIPTION

In the following, the term fastener is generally understood to mean building components which are used to connect other building elements together detachably or non-detachably. In particular, the term “fastener” is understood in connection with this invention to mean screws, in particular self-drilling screws and thread-forming screws. Other fasteners, e.g. screws with a displacement tip or point-shaped tip, but also bolts, nails, rivets or suchlike, can also profit from a coating according to the invention or a coating agent according to the invention.

In the following, coating should be understood in the broadest sense to mean a coat, a layer, a lining on a surface. Not only homogeneously thick, closed coatings are understood, but also those which are applied only on parts of a surface of a fastener and can vary in the application thickness. The nature of the coating can be solid, leathery, waxy, vitreous or viscous.

In the context of the present invention, coating agent should be understood to mean any agent with which a coating is obtained. The nature of the coating agent can be liquid, solid, powdery or gaseous. The coating agent can, when deposited as a coating on a fastener, have a friction-reducing and also a (actively) cooling effect.

Coating process is intended to relate to all measures with which a coating can be obtained. These may be understood to mean dipping processes in liquids, spraying, vapor deposition, condensation from the gaseous phase, dusting or application by rubbing. The coating processes also include the process steps that are used a) to improve the surface distribution of a deposited coating agent, such as rotation, swiveling in the spray jet, centrifugation for example after a dipping process; but also masking of parts of a fastener in order to prevent coating on certain partial surfaces of a fastener (e.g. on the head) or, on the other hand, precisely to improve the latter (seed layer). They also include b) process steps for binding a deposited coating agent more firmly to the surface to be coated; this may be, depending on the coating agent: drying processes (passive evaporation of the solvent to the surroundings, under vacuum, in a drying oven, under a blower); stoving processes (thermal, UV); chemical reactions (binding), possibly with the surface of the fastener or the surrounding atmosphere; cross-linking of the coating agent for the formation of the coating by means of radiation or activators.

The term solution is understood in the present substantive context to mean a liquid, which in the chemical sense can represent a homogeneous mixture comprising at least two chemical substances, but also can be present as a heterogeneous substance mixture, emulsion or suspension; also viscous as a sludge or slurry.

A solid lubricant in the sense of the present invention is a lubricant which is present as a constituent in the solution which can be distinguished from the solution, for example as a micro-granulate. This is also explicitly understood to mean that a liquid or wax-like lubricant is present in a micro-capsule.

Thread-forming screws can be used without pre-drilling in steel sheets or sheet stacks up to a thickness typically of approximately 3 mm, said screws being manufactured from cold-formed carbon steel and comprising a very fine tip with a tip angle of 20-30°. A drilling screw is therefore used only where a thread-forming screw without a drill bit would fail. It is known from tests that drilling screws with a coating according to the prior art, for example with DF921, have a service life of up to 20s when they are used in a drill test stand with 300N feed force at 1800 revs/min. As a test material, use was made on the one hand of a sheet stack of 2 mm steel S355 on 10 mm steel S500 (application 1) and respectively a single sheet of 13 mm steel S355 (application 2). With a coating according to the prior art, failure rates between 20% (application 1) and 70% (application 1) were noted. In reality, this is very problematic for the user, because the post-treatment of such failed setting operations is time-consuming and cost-intensive.

The tests carried out within the scope of the invention therefore proceeded from the typical case of application that the setting operation of a drilling screw, in the usual technical application environment, is an operation which lasts in the range from 5 to 20 seconds. In the case of softer material, higher penetration capacities can be achieved than in the case of harder steel; the performance of the setting device produced in terms of time is however essentially independent of the material.

The technical-physical operations thus take place in a very narrow time window. To the surprise of the inventors, however, huge increases in the drilling performance can be achieved by the fact that, instead of the solutions known from the prior art with only one type of solid lubricant, solutions with at least two types of solid lubricant are used. The invention showed that the lubricating and cooling effect of the solid lubricants becomes critical chiefly towards the end of the operation and that the combination of the two solid lubricants delays the failure time for this application much longer than would have been expected.

In the case of application, the described solid lubricants experience different, thermally induced phase changes. In the simplest case, this is a melting process and an evaporation process. In the case of two different solid lubricants, therefore, up to four phase changes take place offset in time, which each delay the increase in the thermal load.

The present invention can thus be broken down as follows:

A coating agent according to the present invention comprises at least two different solid lubricants, wherein the first solid lubricant is a plastic or a wax and the second solid lubricant is at least one further plastic. Preferably, but not necessarily, these solid lubricants are present in a solution, as it were in a carrier liquid. It is however also conceivable for the substances to be used as a dry mixture.

When a solution is used, then preferably this is a solution having a water base, an alcohol base or another, in particular organic solvent, or a mixture of the aforementioned constituents. Aqueous solutions are preferred from the process-related standpoint and also from safety and environmental aspects.

Particularly good results are achieved if the solid lubricants are present as a micro-granulate, preferably in a nominal size between 5 and 20 μm. On the one hand, a better distribution in the coating is thus achieved and therefore a better availability of the solid lubricants in the case of use.

If a plastic is selected as the first or second solid lubricant, thermoplastics are in each case the preferred plastics. As previously mentioned, the first and second solid lubricants are different. Thus, polyethylene (PE) has been tried and tested as a constituent of the first solid lubricant, the thermoplastic polyvinyl chloride (PVC) and/or polyvinyl butyral (PVB) as a constituent of the second solid lubricant.

As an alternative to a thermoplastic as the first solid lubricant, use may also be made of wax, in particular paraffin, stearin or a mixture thereof. As previously mentioned, waxes can be used as a granulate or as microcapsules. In the latter case, paraffin can also be present as a liquid in a capsule membrane—and should, as mentioned, be considered as a macroscopic solid lubricant. In particular, PCMs usable as a heat buffer have surprisingly proved to be a readily available and effective solid lubricant. The use according to the invention dispenses with reversibility; the employed wax constituents and the possibility of readily distributing microcapsules on the fastener are presumably jointly responsible for the improved effect.

The mixture ratio between the first and second solid lubricant is preferably between 5:1 and 1:1 (related to the weight).

In an alternative approach, the invention can also be regarded as the use of a mixture comprising at least two different substances as solid lubricants, wherein the first substance is a plastic or a wax and the second substance is at least one further plastic. All further material and functional explanations and data above are analogously applicable to this approach.

In principle, a method for coating a fastener can be described with the following steps:

preparation of a fastener to be coated,

application of a coating agent as described above,

solidification of the applied coating agent.

Depending on the initial state of the fastener to be coated, a preliminary treatment can take place before the actual application step, which treatment can comprise, depending on the requirements, a single step, a sequence of steps or a cyclical repetition of one or more steps. Preliminary treatment can be understood to mean a cleaning step, the covering of partial surfaces, the preliminary treatment of partial surfaces for improving the absorption capacity of the coating agent. This wetting of the fastener can also have the purpose, for example, of causing specific regions (recesses, ridges) to be particularly absorbent for the coating. Conversely, process steps can also be taken to exclude specific surface areas, partial surface areas, from the coating, for example in order that such a coating does not become effective on a painted head or a force engagement.

The actual application of the coating agent is essentially determined by the nature of the coating agent (solid, liquid). Depending on the requirement, a single or repeated application of a single process step or a sequence of process steps such as

dipping process,

spray process,

vapour deposition process,

centrifuge process,

powder coating
can come into consideration.

In the case of dipping processes, the fasteners are completely or partially immersed in the coating agent. In the spray process, the fastener is sprayed instead of being immersed, in the vapor deposition process it is subjected to a (coating agent) vapor source. In all cases, the fasteners can be arranged individually, as bulk material in baskets or charged on racks or perforated plates. The centrifuge process is a dipping process, in which the fasteners present in a basket are first immersed and then excess coating agent is spun off. It is also conceivable for a dry mixture of solid lubricants to be deposited on statically loaded fasteners, similar to a powder coating.

The step of “solidification” of the deposited coating agent combines various downstream processes, which are used to fix the deposited coating agent. They may be, depending on the application method and the coating agent used: drying, UV-curing, stoving, cross-linking. Common technical aids for this purpose are ovens, radiation devices, vacuum drying or storage places to allow a chemical reaction to proceed. Depending on the use profile, these solidification steps can be carried out repeatedly and/or as a sequence.

The fasteners referred to in the present method are, as mentioned, preferably screws, self-drilling and/or thread-forming screws, rivets or nails. The applicability of the method should not be understood here as being restricted to coating agents on the described fasteners; the applicability is able to be transferred to similar cases of application.

As a preferred variant of application, it has emerged here to supplement commercially produced coating agents with the components in each case lacking according to the invention. This also permits established coating methods to be reused for such an agent. Wholly within the sense of the invention, an aqueous solution with microencapsulated waxes can thus be supplemented with a micro-granulated thermoplastic or thermoplastic mixture.

Tests have shown that, in test arrangements as described above (arrangement 1 and 2) with coatings according to the prior art, failure rates of over 50% occur. A coating with a mixture comprising 2 thermoplastics reduces the failure rate to 10% or less. In particular, it is noteworthy that even 9× fewer failures were found with a test arrangement with a sandwich comprising 50 mm mineral wool on 10 mm steel S500.

1. A coating agent comprising at least first and second different solid lubricants, the first solid lubricant is a plastic or a wax, and the second solid lubricant is at least one further plastic.

2. The coating agent according to claim 1, wherein the at least first and second solid lubricants are present in a solution.

3. The coating agent according to claim 2, wherein the solution comprises a water-based solution, an alcohol-based solution, an organic solvent-based solution, or a mixture of two or more thereof.

4. The coating agent according to claim 1, wherein the first solid lubricant and the second solid lubricant are present as a micro-granulate.

5. The coating agent according to claim 1, wherein the first solid lubricant is a thermoplastic.

6. The coating agent according to claim 1, wherein the second solid lubricant is a thermoplastic.

7. The coating agent according to claim 6, wherein the thermoplastic comprises polyethylene (PE).

8. The coating agent according to claim 6, wherein the thermoplastic comprises at least one of polyvinyl chloride (PVC) or polyvinyl butyral (PVB).

9. The coating agent according to claim 1, wherein the first solid lubricant is wax and comprises paraffin, stearin or a mixture thereof.

10. A method for coating a fastener with the following steps:
preparing a fastener to be coated,
applying a coating agent comprising at least first and second different solid lubricants, the first solid lubricant is a plastic or a wax, and the second solid lubricant is at least one further plastic, and
solidifying the applied coating agent.

11. The method according to claim 10, further comprising, before the step of applying the coating agent, carrying out a preliminary treatment selected from one or more of:
cleaning, covering of partial surfaces, treating of partial surfaces for improving an absorption capacity for the coating agent.

12. The method according to claim 10, wherein the applying of the coating agent takes place by a single or repeated application of a single process step or a sequence of process steps, including at least one of the following:
a dipping process,
a spray process,
a vapor deposition process,
a centrifuge process, or
powder coating.

13. The method according to claim 10, wherein the solidification of the applied coating agent takes place by a single or repeated application of a single process step or a sequence of process steps, including at least one of the following:
drying or vacuum drying,
UV- or IR-curing,
Stoving, or
cross-linking

14. A fastener with a coating applied by the method according to claim 10, wherein the fastener is one of: a screw, a self-drilling screw, a thread-forming screw, a self-drilling and thread forming screw, a rivet, or a nail.

15. The coating agent according to claim 1, wherein the first solid lubricant and the second solid lubricant are present as a micro-granulate having a grain size of between 5 and 20 μm.
